(19) United States
(12) Patent Application Publication
(10) Pub. No.: US 2006/0024558 A1
(43) Pub. Date: Feb. 2, 2006

(54) LOW PROFILE ELECTROCHEMICAL CELL

(75) Inventors: Jake Friedman, Storrs, CT (US); Frank E. Kenney III, Tolland, CT (US); Benjamin Piecuch, Meriden, CT (US); Everett Anderson, Glastonbury, CT (US)

Correspondence Address: CANTOR COLBURN, LLP, 55 GRIFFIN ROAD SOUTH, BLOOMFIELD, CT, 06002, US

(73) Assignee: Proton Energy Systems, Inc., Wallingford, CT (US)

(21) Appl. No.: 10/710,704

(22) Filed: Jul. 29, 2004

(51) Int. Cl. H01M 8/02; H01M 4/96; H01M 4/94; H01M 8/10

(52) U.S. Cl. 429/38; 429/37; 429/44; 429/30

(57) ABSTRACT

An electrochemical cell is disclosed having a membrane electrode assembly (MEA), a first cell separator plate, a second cell separator plate, and a carbon layer with integrated flowchannels. The MEA includes a first electrode, a second electrode, and a membrane disposed between and in fluid communication with the first and second electrodes. The first cell separator plate is disposed on the first electrode side of the MEA and defines a first flow field therebetween, the first flow field being proximate a first frame member. The second cell separator plate is disposed on the second electrode side of the MEA and defines a second flow field therebetween, the second flow field being proximate a second frame member. The carbon layer with integrated flowchannels is disposed at the first flow field, the flowchannels having a flow width that is equal to or less than the width of the webbing between adjacent flowchannels.

### BACKGROUND OF INVENTION

The present disclosure relates generally to electrochemical cells, and particularly to electrochemical cells having a low profile.

Electrochemical cells are energy conversion devices, usually classified as either electrolysis cells or fuel cells. A proton exchange membrane electrolysis cell can function as a hydrogen generator by electrolytically decomposing water to produce hydrogen and oxygen gas, and can function as a fuel cell by electrochemically reacting hydrogen with oxygen to generate electricity. Referring to FIG. 1, which is a partial section of a typical anode feed electrolysis cell 100, process water 102 is fed into cell 100 on the side of an oxygen electrode (anode) 116 to form oxygen gas 104, electrons, and hydrogen ions (protons) 106. The reaction is facilitated by the positive terminal of a power source 120 electrically connected to anode 116 and the negative terminal of power source 120 connected to a hydrogen electrode (cathode) 114. The oxygen gas 104 and a portion of the process water 108 exits cell 100, while protons 106 and water 110 migrate across a proton exchange membrane 118 to cathode 114 where hydrogen gas 112 is formed.

Another typical water electrolysis cell using the same configuration as is shown in FIG. 1 is a cathode feed cell, wherein process water is fed on the side of the hydrogen electrode. A portion of the water migrates from the cathode across the membrane to the anode where hydrogen ions and oxygen gas are formed due to the reaction facilitated by connection with a power source across the anode and cathode. A portion of the process water exits the cell at the cathode side without passing through the membrane.

A typical fuel cell uses the same general configuration as is shown in FIG. 1. Hydrogen gas is introduced to the hydrogen electrode (the anode in fuel cells), while oxygen, or an oxygen-containing gas such as air, is introduced to the oxygen electrode (the cathode in fuel cells). Water can also be introduced with the feed gas. The hydrogen gas for fuel cell operation can originate from a pure hydrogen source, hydrocarbon, methanol, or any other hydrogen source that supplies hydrogen at a purity suitable for fuel cell operation (i.e., a purity that does not poison the catatlyst or interfere with cell operation). Hydrogen gas electrochemically reacts at the anode to produce protons and electrons, wherein the electrons flow from the anode through an electrically connected external load, and the protons migrate through the membrane to the cathode. At the cathode, the protons and electrons react with oxygen to form water, which additionally includes any feed water that is dragged through the membrane to the cathode. The electrical potential across the anode and the cathode can be exploited to power an external load.

In other embodiments, one or more electrochemical cells can be used within a system to both electrolyze water to produce hydrogen and oxygen, and to produce electricity by converting hydrogen and oxygen back into water as needed. Such systems are commonly referred to as regenerative fuel cell systems.

Electrochemical cell systems typically include a number of individual cells arranged in a stack, with the working fluids directed through the cells via input and output conduits formed within the stack structure. The cells within the stack are sequentially arranged, each including a cathode, a proton exchange membrane, and an anode. The cathode and anode may be separate layers or may be integrally arranged with the membrane. Each cathode/membrane/anode assembly (hereinafter “membrane electrode assembly”, or “MEA”) typically has a first flow field in fluid communication with the cathode and a second flow field in fluid communication with the anode. The MEA may furthermore be supported on both sides by screen packs or bipolar plates disposed within flow fields. Screen packs or bipolar plates may facilitate fluid movement to and from the MEA, membrane hydration, and may also provide mechanical support for the MEA.

In order to maintain intimate contact between cell components under a variety of operational conditions and over long time periods, uniform compression is applied to the cell components. Pressure pads or other compression means are often employed to provide even compressive force from within the electrochemical cell. Pressure pads may be fabricated from materials incompatible with system fluids and/or the cell membrane, thereby requiring the pressure pad to be disposed within a protective encasing or otherwise isolated from the system fluids.

While existing internal components are suitable for their intended purposes, there still remains a need for improvement, particularly regarding cell efficiency at lower cost, weight and size. Accordingly, a need exists for improved internal cell components of an electrochemical cell that can operate at sustained high pressures and low resistivities, while offering a low profile configuration.

### BRIEF DESCRIPTION OF THE INVENTION

Embodiments of the invention disclose an electrochemical cell having a membrane electrode assembly (MEA), a first cell separator plate, a second cell separator plate, and a carbon layer with integrated flowchannels. The MEA includes a first electrode, a second electrode, and a membrane disposed between and in fluid communication with the first and second electrodes. The first cell separator plate is disposed on the first electrode side of the MEA and defines a first flow field therebetween, the first flow field being proximate a first frame member. The second cell separator plate is disposed on the second electrode side of the MEA and defines a second flow field therebetween, the second flow field being proximate a second frame member. The carbon layer with integrated flowchannels is disposed at the first flow field, the flowchannels having a flow width that is equal to or less than the width of the webbing between adjacent flowchannels.

Other embodiments of the invention disclose an electrochemical chemical cell having an MEA, a first cell separator plate, a second cell separator plate, and a porous carbon gas diffusion layer (GDL). The MEA includes a first electrode, a second electrode, and a membrane disposed between and in fluid communication with the first and second electrodes. The first cell separator plate is disposed on the first electrode side of the MEA and defines a first flow field therebetween, the first flow field being proximate a first frame member. The second cell separator plate is disposed on the second electrode side of the MEA and defines a second flow field therebetween, the second flow field being proximate a second frame member. The GDL is disposed at the first flow field and is in intimate contact with the MEA. The GDL has an electrical resistivity of equal to or less than about 0.73 Ohm-centimeters at a compressive load at the GDL of about 100 pounds-per-square-inch.

### BRIEF DESCRIPTION OF THE DRAWINGS

Referring now to the figures wherein like elements are numbered alike:

FIG. 1 depicts a schematic diagram of a partial electrochemical cell showing an electrochemical reaction for use in accordance with embodiments of the invention;

FIG. 2 depicts an exploded assembly isometric view of an exemplary electrochemical cell in accordance with embodiments of the invention;

FIG. 3 depicts an expanded partial section cut through the assembly of FIG. 2;

FIGS. 4-7 depict expanded schematic diagrams of alternative electrochemical cells to that depicted in FIG. 2;

FIG. 8 depicts a set of curves illustrating a mechanical characteristic of different materials suitable for use in embodiments of the invention;

FIG. 9 depicts a set of curves illustrating an electrical characteristic of different material arrangements suitable for use in embodiments of the invention; and

FIGS. 10-13 depict alternative configurations of a gas diffusion layer in accordance with embodiments of the invention.

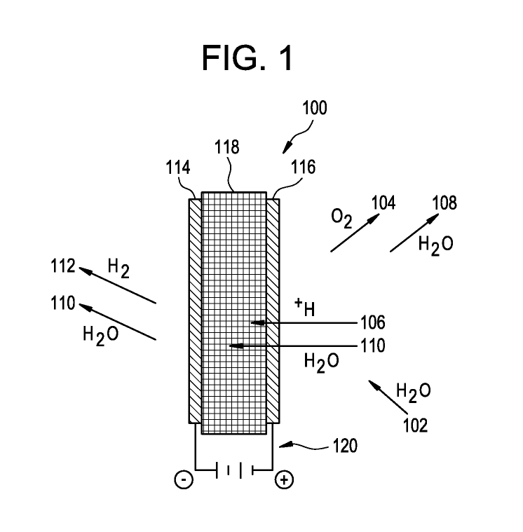

### DETAILED DESCRIPTION OF THE INVENTION

Disclosed herein are novel embodiments for an electrochemical cell having electrically conductive, elastically compressible, and hydrogen compatible, carbon components strategically disposed within the cell.

Although the disclosure below is described in relation to a proton exchange membrane electrochemical cell employing hydrogen, oxygen, and water, other types of electrochemical cells and/or electrolytes and/or reactants may be used in accordance with embodiments of the invention and the teachings disclosed herein. Upon the application of different reactants and/or different electrolytes, the flows and reactions are understood to change accordingly, as is commonly understood in relation to that particular type of electrochemical cell.

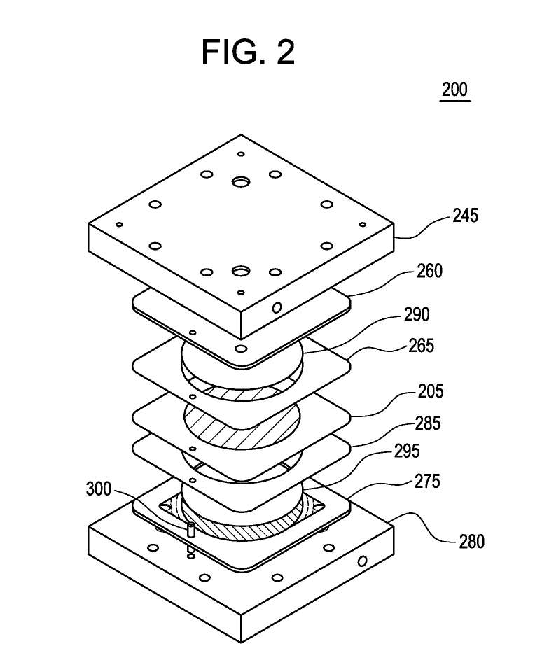

Referring to FIG. 2, an electrochemical cell (cell) 200 suitable for operation as an anode feed electrolysis cell, cathode feed electrolysis cell, fuel cell, or regenerative fuel cell is depicted in an exploded assembly isometric view. Thus, while the discussion below is directed to an anode feed electrolysis cell, cathode feed electrolysis cells, fuel cells, and regenerative fuel cells are also contemplated. Cell 200 is typically one of a plurality of cells employed in a cell stack as part of an electrochemical cell system. When cell 200 is used as an electrolysis cell, power inputs are generally between about 1.48 volts and about 3.0 volts, with current densities between about 50 A/ft² (amperes per square foot) and about 4,000 A/ft². When used as a fuel cells power outputs range between about 0.4 volts and about 1 volt, and between about 0.1 A/ft² and about 10,000 A/ft². The number of cells within the stack, and the dimensions of the individual cells is scalable to the cell power output and/or gas output requirements. Accordingly, application of electrochemical cell 200 may involve a plurality of cells 200 arranged electrically either in series or parallel depending on the application.

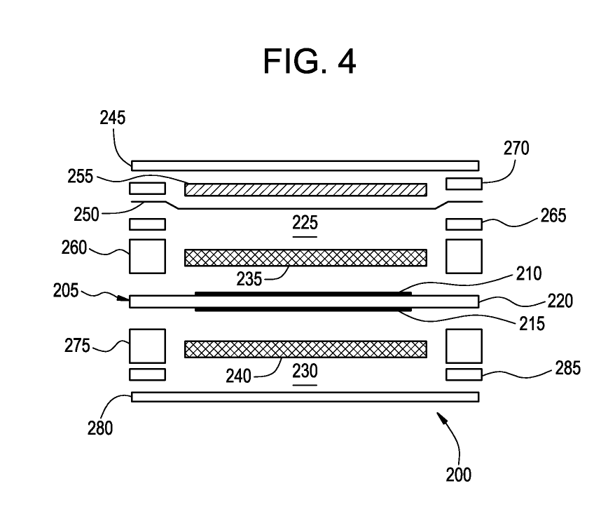

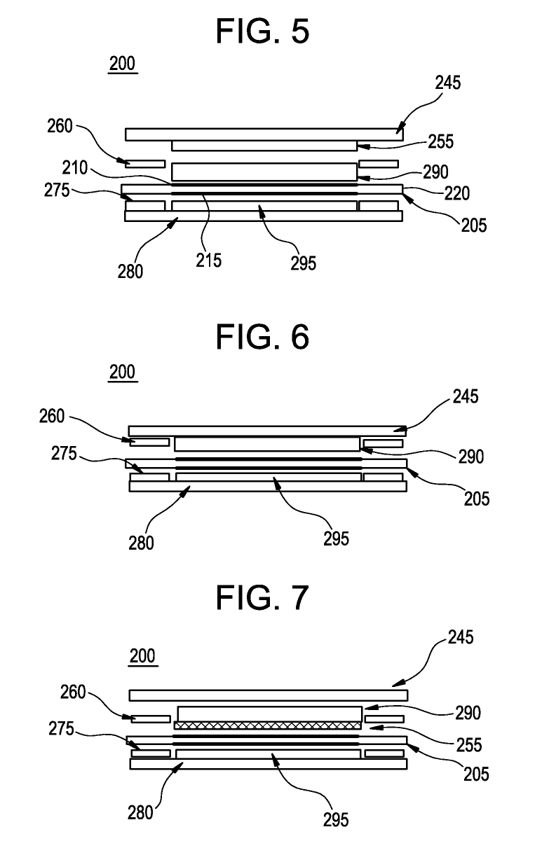

Cells may be operated at a variety of pressures, such as up to or exceeding about 100 psi, up to or exceeding about 500 psi, up to or exceeding about 2500 psi, or even up to or exceeding about 10,000 psi, for example. Cell 200 includes a membrane-electrode-assembly (MEA) 205 having a first electrode (e.g., cathode) 210 and a second electrode (e.g., anode) 215 disposed on opposite sides of a proton exchange membrane (membrane) 220, best seen by now referring to FIG. 4. Flow fields 225, 230, which are in fluid communication with electrodes 210 and 215, respectively, are defined generally by the regions proximate to, and bounded on at least one side by, each electrode 210 and 215 respectively. A flow field member 235 may be disposed within flow field 225 between electrode 210, a cell separator plate 245 and, optionally, a pressure pad separator plate 250. A pressure pad 255 may be disposed between pressure pad separator plate 250 and cell separator plate 245. In an embodiment, cell separator plate 245 is disposed adjacent to pressure pad 255. In alternative embodiments, such as depicted in FIGS. 5-7 for example, alternative components may be used for flow field member 235 and pressure pad 255, as will be discussed later in more detail with reference to FIGS. 5-7. A frame 260 generally surrounds flow field 225 and an optional gasket 265 may be disposed between frame 260 and pressure pad separator plate 250 generally for enhancing the seal within the reaction chamber defined on one side of cell 200 by frame 260, pressure pad separator plate 250 and electrode 210. Another gasket 270 may be disposed between pressure pad separator plate 250 and cell separator plate 245 enclosing pressure pad 255.

Another flow field member 240 may be disposed in flow field 230. A frame 275 generally surrounds flow field member 240, a cell separator plate 280 is disposed adjacent flow field member 240 opposite oxygen electrode 215, and a gasket 285 is disposed between frame 275 and cell separator plate 280, generally for enhancing the seal within the reaction chamber defined by frame 275, cell separator plate 280, and the oxygen side of membrane 220. The cell components, particularly cell separator plates (also referred to as manifolds) 245, 280, frames 260, 275, and gaskets 265, 270, and 285 may be formed with suitable manifolds or other conduits for fluid flow.

Membrane 220 comprises electrolytes that are preferably solids or gels under the operating conditions of the electrochemical cell. Useful materials include proton conducting ionomers and ion exchange resins. Useful proton conducting ionomers include complexes comprising an alkali metal salt, alkali earth metal salt, a protonic acid, or a protonic acid salt. Useful complex-forming reagents include alkali metal salts, alkaline metal earth salts, and protonic acids and protonic acid salts. Counter-ions useful in the above salts include halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt is complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene) glycol, poly(oxyethylene-co-oxypropylene) glycol monoether, and poly(oxyethylene-co-oxypropylene) glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with dialkylsiloxanes, maleic anhydride, or polyethylene glycol monoethyl ether with methacrylic acid are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divi nyl benzene copolymers, styrene-butadiene copolymers, styrene-divinyl-benzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins can include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases. One family of fluorocarbon-type resins having sulfonic acid group functionality is NAFION™ resins (commercially available from E. I. du Pont de Nemours and Company, Wilmington, Del.).

Electrodes 210 and 215 comprise a catalyst suitable for performing the needed electrochemical reaction (i.e., electrolyzing water and producing hydrogen). Suitable catalyst include, but are not limited to, materials comprising platinum, palladium, rhodium, carbon, gold, tantalum, tungsten, ruthenium, iridium, osmium, alloys of at least one of the foregoing catalysts, and the like. Electrodes 210 and 215 can be formed on membrane 220, or may be layered adjacent to, but in contact with, membrane 220.

In an embodiment, flow field members 235, 240 may be screen packs, bipolar plates, or other support members. A screen or bipolar plate capable of supporting membrane 220, allowing the passage of system fluids, and preferably conducting electrical current is desirable. In an embodiment, the screens may comprise layers of perforated sheets or a woven mesh formed from metal or strands. These screens are typically comprised of metals, such as, for example, niobium, zirconium, tantalum, titanium, carbon steel, stainless steel, nickel, cobalt, and alloys comprising at least one of the foregoing metals. The geometry of the openings in the screens can range from ovals, circles, and hexagons to diamonds and other elongated shapes. Bipolar plates are commonly porous structures comprising fibrous carbon or fibrous carbon impregnated with polytetrafluoroethylene or PTFE (commercially available under the trade name TEFLON® from E. I. du Pont de Nemours and Company). However, the bipolar plates are not limited to carbon or PTFE impregnated carbon, they may also be made of any of the foregoing materials used for the screens, such as niobium, zirconium, tantalum, titanium, carbon steel, stainless steel, nickel, cobalt, and associated alloys, for example.

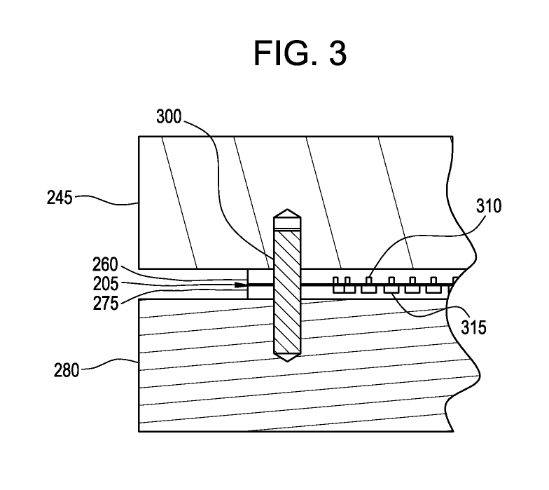

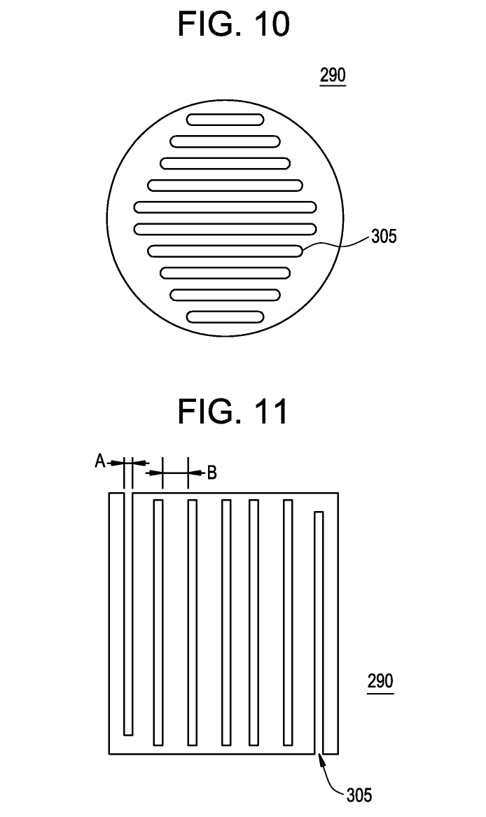

In a preferred embodiment, and referring now to FIGS. 2 and 5-7 collectively, flow field member 235 on the hydrogen side of MEA 205 may be a gas diffusion layer (GDL) 290 fabricated of carbon and having flowchannels 305 (depicted in FIGS. 10-13), flow field member 240 on the oxygen side of MEA 205 may comprise a porous pressure support plate 295, frame 260 and gasket 265 may be integrally combined, and frame 275 and gasket 285 may be integrally combined. An alignment pin 300 may be used to maintain the alignment of the components of cell 200. FIG. 3, which depicts an expanded partial section cut through the assembly of FIG. 2 through pin 300, exemplifies flowchannels 310 and 315 in frame 260 and 275, respectively.

Pressure pad 255 provides for uniform compression between cell components and may comprise a resilient member or an elastically compressible member. Where pressure pad 255 comprises a resilient member, an elastomeric material is preferable. Suitable elastomeric materials include, but are not limited to silicones, such as, for example, fluorosilicones; fluoroelastomers, such as KALREZ® (commercially available from E. I. du Pont de Nemours and Company), VITON® (commercially available from E. I. du Pont de Nemours and Company), and FLUOREL® (commercially available from Minnesota Mining and Manufacturing Company, St. Paul, Minn.); and combinations thereof.

Where pressure pad 255 comprises an elastically compressible member, a compressible carbon material absent metal or metallic plating is preferable. Suitable compressible carbon materials include, but are not limited to carbon paper, carbon sheet, or carbon cloth, such as B-1 carbon cloth or B-2 Toray carbon paper (commercially available from E-TEK, De Nora Elettrodi Network) and TGP-H-1.0t and TGP-H-1.5t (commercially available from Toray, Inc.). When used without pressure pad separator plate 250, pressure pad 255 may be porous to allow passage of water or system gases.

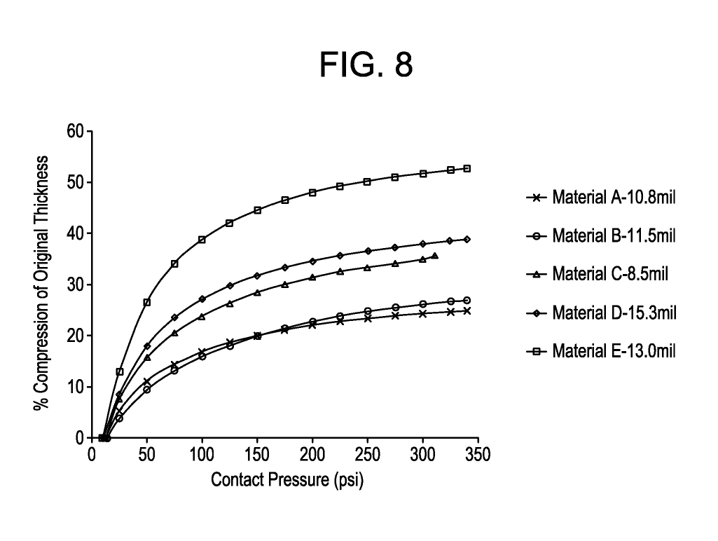

In an embodiment, it has been found that pressure pad 255 made from elastically compressible carbon material as herein disclosed, and having an overall thickness equal to or greater than about 7 mils (1 mil=0.001 inches) and equal to or less than about 125 mils, may produce equal to or greater than about 150 psi (pounds per square inch) of contact pressure at MEA 205 at a compression amount of equal to or greater than about 15% of its original thickness. Test results relating to various carbon materials at various thicknesses showing percent compression of original thickness as a function of pressure are illustrated in FIG. 8. As illustrated, five materials of elastically compressible carbon material (Material A, B, C, D and E) exhibit a contact pressure of equal to or greater than about 100 psi at a compression amount of equal to or greater than about 15% of original thickness, and a contact pressure of equal to or greater than about 150 psi at a compression amount of equal to or greater than about 20% of original thickness. As depicted, Material A has an original thickness of 10.8 mil (1 mil=0.001 inches), Material B has an original thickness of 11.5 mil, Material C has an original thickness of 8.5 mil, Material D has an original thickness of 15.3 mil, and Material D has an original thickness of 13.0 mil, thereby indicating that embodiments of the invention are not limited to any one material thickness.

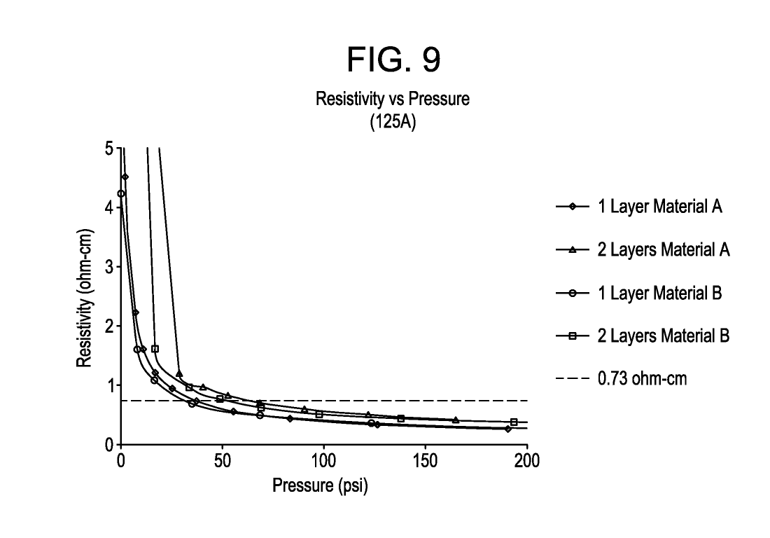

In an embodiment, it has also been found that pressure pad 255 comprising elastically compressible carbon material as herein disclosed has an electrical resistivity of equal to or less than about 0.73 Ohm-centimeters (Ohm-cm) at a compressive load of equal to or greater than about 100 psi, making it suitable for use in the electrical path of cell 200. Test results relating to various carbon materials showing electrical resistivity as a function of pressure at an electrical current of 125 A (Amps) are illustrated in FIG. 9. As illustrated, four material arrangements of elastically compressible carbon material (Material A single layer, Material A double layer, Material B single layer, and Material C double layer) exhibit a resistivity of equal to or less than about 0.73 Ohm-cm at a compressive load of equal to or greater than about 100 psi, and even exhibit a resistivity of equal to or less than about 0.73 Ohm-cm at a compressive load of equal to or greater than about 50 psi. As depicted, the material arrangements may have one or more layers, and while only single and double layers are depicted, it will be appreciated that the invention is not so limited and may have any number of layers that are suitable for the purposes disclosed herein.

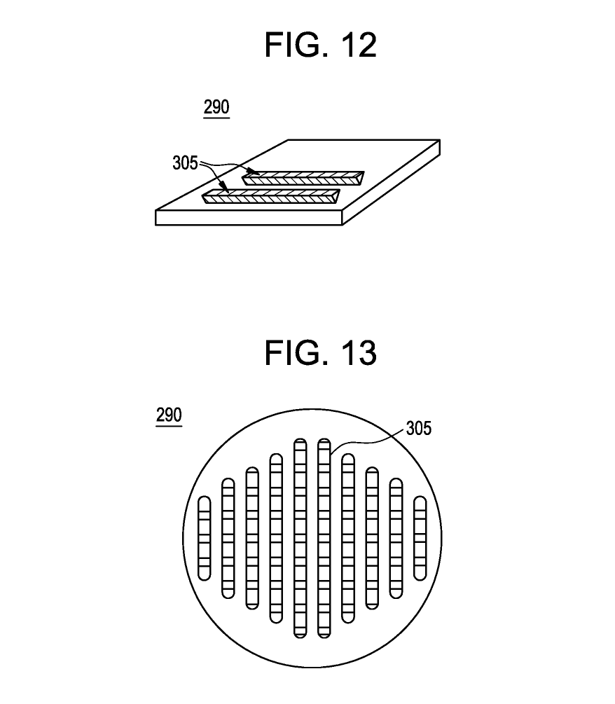

In an embodiment, GDL 290 is fabricated of carbon paper, sheet or cloth as herein disclosed, and also includes flowchannels 305, best seen by now referring to FIGS. 10-13. In FIG. 10, GDL 290 is depicted having flowchannels 305 pierced through the material thickness and contained inboard of the edge of GDL 290. In FIG. 11, GDL 290 is depicted having flowchannels 305 extending to the edge of GDL 290. In an embodiment, the width A of flowchannels 305 is equal to or less than the width B of the webbing between adjacent flowchannels 305. In FIG. 12, GDL 290 is depicted having flowchannels 305 embossed within the material thickness and not pierced through the material thickness. In FIG. 13, GDL 290, similar to that of FIG. 10, is depicted having two layers of material with their respective flowchannels 305 being oriented 90 degrees to each other. While FIG. 13 depicts only two layers of carbon material for GDL 290, it will be appreciated that any number of layers may be employed with their respective flowchannels being oriented at any angle suitable for permitting lateral (x, y) and longitudinal (z) flow through GDL 290. Where GDL 290 includes flowchannels 305, hydrogen frame 260 may be absent flowchannels 310.

Referring now back to FIGS. 5-7, various configurations of the components within cell 200 are illustrated. In FIG. 5, contained within flow field 225 is pressure pad 255 and GDL 290. Here, GDL 290 is a carbon material having integrated flowchannels 305 (see FIGS. 10-13), and pressure pad 255 may or may not be a carbon material (paper, sheet or cloth). Where pressure pad 255 is compressible carbon, as herein disclosed, GDL 290 may be made of a solid carbon material. Where pressure pad 255 and GDL 290 are both made of compressible carbon, the respective functions of the two may be combined into one part, as depicted in FIG. 6, thereby providing for a lower profile cell 200. Where pressure pad 255 is disposed in intimate contact with electrode 210 of MEA 205, as depicted in FIG. 7, pressure pad 255 is preferably made of porous carbon that may or may not be compressible. Where pressure pad 255 is not compressible, still referring to FIG. 7, then GDL 290 is preferably compressible, and vice versa.

As discussed, GDL 290 and pressure pad 255 may either or both be fabricated from compressible carbon (paper, sheet or cloth), and as also discussed and illustrated, compressible carbon suitable for the purposes disclosed herein preferably exhibits an electrical resistivity of equal to or less than about 0.73 Ohm-centimeters at a compressive load of equal to or greater than about 100 psi. Also, the compressible carbon material for the purposes disclosed herein preferably exhibits a mechanical characteristic sufficient to maintain a surface pressure at MEA 205 of equal to or greater than about 150 psi at a compression amount of equal to or greater than about 15% of its initial thickness, over an extended period of time.

An exemplary embodiment using E-TEK Toray 11.5 mil thick carbon paper successfully produced equal to or greater than about 150 psi of pressure at equal to or greater than about 15% compression of initial thickness, with sustained pressure for over 2000 hours, and contemplated sustained pressure for tens of thousands of hours. The electrical resistivity of the carbon paper at a pressure greater than about 100 psi was also measured to be less than 0.73 Ohm-cm.

In view of the foregoing, some embodiments of the invention may have some of the following advantages: hereherea lower profile cell configuration having lower weight, size and cost; fewer plated parts resulting in fewer manufacturing process steps and process time; lateral and longitudinal (x, y and z) flow without having to create microchannels in the cell frame; and, a hydrogen compatible flow field member that is electrically conductive, elastically compressible, and suitable for replacing typical metal-rubber composite pressure pads and plated metal screen packs.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. An electrochemical cell comprising:
a membrane electrode assembly (MEA) comprising a first electrode, a second electrode, and a membrane disposed between and in fluid communication with the first and second electrodes;
a first cell separator plate disposed on the first electrode side of the MEA and defining a first flow field therebetween, the first flow field proximate a first frame member;
a second cell separator plate disposed on the second electrode side of the MEA and defining a second flow field therebetween, the second flow field proximate a second frame member; and
a carbon layer with integrated flowchannels disposed at the first flow field;
wherein the flowchannels have a flow width that is equal to or less than the width of the webbing between adjacent flowchannels.

2. The electrochemical cell of claim 1, wherein the carbon layer is compatible with a hydrogen environment, and has an electrical resistivity of equal to or less than about 0.73 Ohm-centimeters.

3. The electrochemical cell of claim 2, wherein the carbon layer has an electrical resistivity of equal to or less than about 0.73 Ohm-centimeters at a compressive load at the carbon layer of about 100 pounds-per-square-inch.

4. The electrochemical cell of claim 1, further comprising:
a pressure pad disposed between the first cell separator plate and the carbon layer sufficient to maintain a surface pressure at the MEA of equal to or greater than about 150 pounds-per-square-inch.

5. The electrochemical cell of claim 4, wherein the pressure pad consists essentially of compressible carbon.

6. The electrochemical cell of claim 1, wherein the carbon layer is compressible sufficient to maintain a surface pressure at the MEA of equal to or greater than about 150 pounds-per-square-inch.

7. The electrochemical cell of claim 1, wherein the carbon layer is absent metal or metallic plating.

8. The electrochemical cell of claim 1, wherein the carbon layer comprises carbon paper, carbon sheet, carbon cloth, or any combination comprising at least one of the foregoing.

9. The electrochemical cell of claim 1, wherein the carbon layer is porous and is in intimate contact with the MEA, the porosity being sufficient for the diffusion of gas and liquid.

10. The electrochemical cell of claim 1, wherein the first frame member is absent fluid flow channels.

11. The electrochemical cell of claim 1, wherein the carbon layer is an assembly comprising:
a first layer having first fluid flowchannels oriented in a first direction; and
a second layer having second fluid flowchannels oriented in a second different direction;
wherein the first and second fluid flowchannels of the assembly permit lateral and longitudinal flow therethrough.

12. The electrochemical cell of claim 11, wherein the first fluid flowchannels, the second fluid flowchannels, or both, are pierced through the first and the second layer, respectively.

13. The electrochemical cell of claim 11, wherein the first fluid flowchannels, the second fluid flowchannels, or both, are embossed into the material of the first and the second layer, respectively.

14. The electrochemical cell of claim 1, wherein the flowchannels extend to the edge of the carbon layer.

15. The electrochemical cell of claim 6, wherein the carbon layer is compressible sufficient to maintain a surface pressure at the MEA of equal to or greater than about 150 pounds-per-square-inch at a compression amount at the carbon layer of equal to or greater than about 15% of its initial thickness.

16. The electrochemical cell of claim 1, further comprising:
a porous support plate disposed between the MEA and the second cell separator plate.

17. The electrochemical cell of claim 1, further comprising:
a first gasket disposed between the first frame member and the MEA, and a second gasket disposed between the second frame member and the MEA, the gaskets suitable for gas and liquid sealing.

18. The electrochemical cell of claim 1, further comprising:
a porous carbon gas diffusion layer (GDL) disposed between the carbon layer and the MEA.

19. The electrochemical cell of claim 18, wherein the GDL is compressible sufficient to maintain a surface pressure at the MEA of equal to or greater than about 150 pounds-per-square-inch.

20. The electrochemical cell of claim 18, wherein the GDL has an electrical resistivity of equal to or less than about 0.73 Ohm-centimeters at a compressive load at the GDL of about 100 pounds-per-square-inch.

21. The electrochemical cell of claim 18, wherein the GDL comprises carbon paper, carbon sheet, carbon cloth, or any combination comprising at least one of the foregoing.

22. The electrochemical cell of claim 18, wherein the carbon layer and the GDL each consist essentially of carbon.

23. An electrochemical cell comprising:
a membrane electrode assembly (MEA) comprising a first electrode, a second electrode, and a membrane disposed between and in fluid communication with the first and second electrodes;
a first cell separator plate disposed on the first electrode side of the MEA and defining a first flow field therebetween, the first flow field proximate a first frame member;
a second cell separator plate disposed on the second electrode side of the MEA and defining a second flow field therebetween, the second flow field proximate a second frame member; and
a porous carbon gas diffusion layer (GDL) disposed at the first flow field and in intimate contact with the MEA; wherein the GDL has an electrical resistivity of equal to or less than about 0.73 Ohm-centimeters at a compressive load at the GDL of about 100 pounds-per-square-inch.

24. The electrochemical cell of claim 23, wherein the GDL is compressible sufficient to maintain a surface pressure at the MEA of equal to or greater than about 150 pounds-per-square-inch.

25. The electrochemical cell of claim 23, wherein the GDL consists essentially of compressible carbon.

26. The electrochemical cell of claim 23, wherein the GDL is porous and is in intimate contact with the MEA, the porosity being sufficient for the diffusion of gas and liquid.

27. The electrochemical cell of claim 23, wherein the GDL is compressible sufficient to maintain a surface pressure at the MEA of equal to or greater than about 150 pounds-per-square-inch at a compression amount at the GDL of equal to or greater than about 15% of its initial thickness.
